(19) United States
(12) Patent Application Publication
(10) Pub. No.: US 2020/0029668 A1
(43) Pub. Date: Jan. 30, 2020

(54) HANGER DEVICES AND ASSEMBLIES FOR MOUNTING BLOW DRYERS

(71) Applicant: Jennifer Lynn West, Van Nuys, CA (US)

(72) Inventor: Jennifer Lynn West, Van Nuys, CA (US)

(21) Appl. No.: 16/047,244

(22) Filed: Jul. 27, 2018

(51) Int. Cl. A45D 20/12; F16M 13/02

(52) U.S. Cl. CPC A45D 20/12; F16M 13/022

(57) ABSTRACT

A hanger device for mounting a blow dryer is provided which includes at least one elongate member having a first end and a second end. The elongate member forms a surface mounting section near the first end defining an attachment gap and a blow dryer support section near the second end. The blow dryer support section includes a substantially circular sway bar for resting an underside of a blow dryer. The substantially circular sway bar defines a gap configured to receive a blow dryer. The blow dryer support section defines one or more directional slots for positioning a nozzle of a blow dryer in a desired direction. The at least one elongate member may be a single elongate member so the entire hanging device is one continuous flow. The hanging device may further comprise a fastener fitted through the attachment gap to affix the hanger device to a wall, mirror, or other vertical surface. The blow dryer support section may define an open pass-through for an electrical cord between the sway bar and the directional slots to facilitate removal of a blow dryer. The position of a blow dryer can be changed by turning the blow dryer and moving the nozzle from a first directional slot to a second directional slot.

### FIELD OF THE DISCLOSURE

The present disclosure relates to hanger devices, assemblies, and methods, including hanger devices and assemblies for mounting blow dryers.

### BACKGROUND

For individuals styling their hair, it is difficult to simultaneously brush and dry wet hair. In particular, it is awkward to hold a blow dryer in one hand to dry hair and a brush in the other hand to style the hair. For some disabled people, this problem can be particularly acute. The ability to use a blow dryer hands free would be a significant improvement for such individuals.

Individuals using blow dryers in their homes find that the blow dryer can create clutter on counter space in their bathrooms. Also, storing and retrieving a blow dryer on a daily basis can be frustrating and time-consuming. Using a blow dryer away from home also can be difficult. When traveling, hotel rooms typically do not have blow dryer holders for individuals who bring their blow dryers with them. In addition, existing blow dryer holders require complex or time-consuming attachment procedures to affix them to a wall.

Thus, there is a need for a blow dryer holder that provides the ability to dry hair hands-free, and there is also a need for a blow dryer holder that allows for hanging a blow dryer anywhere easily. In addition, there is a need for a blow dryer holder that provides a place to hold the blow dryer when not in use.

### SUMMARY

The present disclosure, in its many embodiments, alleviates to a great extent the disadvantages of known blow dryer holder devices, systems, and methods. The present disclosure describes hanger devices and assemblies in which a continuous flow elongate member forms a surface mounting section with an attachment gap for affixing to a vertical surface and a blow dryer support section with a substantially circular sway bar for resting an underside of a blow dryer and directional slots for positioning a nozzle of a blow dryer in a desired direction.

Disclosed customized hangers are designed so the user can hang the blow dryer anywhere via suction cup, hook, screw, nail, tape, etc., providing the ability to brush, dry, and style hair hands free. Also, when affixed to a wall via screw or nail exemplary hangers provide a suitable home for the dryer when not in use. Exemplary hangers can be used as travel models and for temporary use when affixed via suction cup. Exemplary hangers can be used anywhere as needed. Exemplary custom hangers can be used for holding the blow dryer when drying hair and can also be a “home” for the dryer when not in use if securely fixed to a vertical surface.

Exemplary embodiments of a hanger device comprise at least one elongate member having a first end and a second end. The elongate member forms a surface mounting section near the first end defining an attachment gap and a support section near the second end. The support section includes a substantially circular sway bar defining a receiving gap and defines one or more directional slots. In exemplary embodiments, there are three directional slots. In exemplary embodiments, the support section defines an open pass-through between the sway bar and the directional slots. The at least one elongate member may be a single elongate member and may be comprised of one or more of wire, plastic, and/or aluminum. In exemplary embodiments, the surface mounting section includes one or more bumper stops. The surface mounting section may be vertically oriented. In exemplary embodiments, the attachment gap defines an open bottom.

Exemplary embodiments of a hanger assembly comprise at least one elongate member having a first end and a second end. The elongate member forms a surface mounting section near the first end defining an attachment gap and a support section near the second end. The support section includes a substantially circular sway bar defining a receiving gap and defines one or more directional slots. The hanger assembly further comprises a fastener fitted through the attachment gap. The attachment gap may define an open bottom. The fastener may be a suction cup or one or more of a hook, a screw, a nail, and tape. In exemplary embodiments, the surface mounting section is vertically oriented and the fastener affixes the hanger assembly to a vertical surface such as a wall or a mirror. The surface mounting section may include one or more bumper stops providing clearance for the fastener.

In exemplary embodiments, a hanger device for mounting a blow dryer is provided comprising at least one elongate member having a first end and a second end. The elongate member forms a surface mounting section near the first end defining an attachment gap and a blow dryer support section near the second end. The blow dryer support section includes a substantially circular sway bar for resting an underside of a blow dryer, and the substantially circular sway bar defines a gap configured to receive a blow dryer handle. The blow dryer support section defines one or more directional slots for positioning a nozzle of a blow dryer in a desired direction.

In exemplary embodiments, the hanger device further comprises a fastener fitted through the attachment gap. The surface mounting section may include one or more bumper stops providing clearance for the fastener, and the fastener may affix the hanger device to a vertical surface as a wall or mirror. In exemplary embodiments, the blow dryer support section defines an open pass-through for an electrical cord between the sway bar and the directional slots to facilitate removal of a blow dryer. The at least one elongate member is a single elongate member so the hanger device is one continuous flow. In exemplary embodiments, the position of a blow dryer can be changed by turning the blow dryer and moving the nozzle from a first directional slot to a second directional slot.

Accordingly, it is seen that hanger devices, systems, and methods are provided. These and other features and advantages will be appreciated from review of the following detailed description, along with the accompanying figures in which like reference numbers refer to like parts throughout.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a front perspective view of an exemplary embodiment of a hanger device in accordance with the present disclosure;

FIG. 2 is a front view of an exemplary embodiment of a hanger device in accordance with the present disclosure;

FIG. 3 is a side perspective view of an exemplary embodiment of a hanger device in accordance with the present disclosure;

FIG. 4 is a side view of an exemplary embodiment of a hanger device in accordance with the present disclosure;

FIG. 5 is a side perspective view of an exemplary embodiment of a hanger device in accordance with the present disclosure;

FIG. 6 is a side view of an exemplary embodiment of a hanger device in accordance with the present disclosure;

FIG. 7 is a rear perspective view of an exemplary embodiment of a hanger device in accordance with the present disclosure;

FIG. 8 is a rear view of an exemplary embodiment of a hanger device in accordance with the present disclosure;

FIG. 9 is a top view of an exemplary embodiment of a hanger device in accordance with the present disclosure;

FIG. 10 is a bottom view of an exemplary embodiment of a hanger device in accordance with the present disclosure;

FIG. 11 is a front view of an exemplary embodiment of a hanger assembly in accordance with the present disclosure;

FIG. 12 is a front view of an exemplary embodiment of a hanger assembly mounted to a surface in accordance with the present disclosure;

FIG. 13 is a front view of an exemplary embodiment of a hanger assembly mounted to a surface shown holding a blow dryer in accordance with the present disclosure;

FIG. 14 is a perspective view of an exemplary embodiment of a hanger assembly mounted to a surface shown holding a blow dryer in accordance with the present disclosure;

FIG. 15 is a top view of an exemplary embodiment of a hanger assembly mounted to a surface shown holding a blow dryer in accordance with the present disclosure; and

FIG. 16 is a bottom perspective view of an exemplary embodiment of a hanger assembly mounted to a surface shown holding a blow dryer in accordance with the present disclosure.

### DETAILED DESCRIPTION

In the following detailed description of exemplary embodiments of the disclosure, reference is made to the accompanying drawings in which like references indicate similar elements, and in which is shown by way of illustration specific embodiments in which disclosed systems and devices may be practiced. These embodiments are described in sufficient detail to enable those skilled in the art to practice the embodiments, and it is to be understood that other embodiments may be utilized and that logical, mechanical, functional, and other changes may be made without departing from the scope of the present disclosure. The following detailed description is, therefore, not to be taken in a limiting sense, and the scope of the present disclosure is defined by the appended claims. As used in the present disclosure, the term “or” shall be understood to be defined as a logical disjunction and shall not indicate an exclusive disjunction.

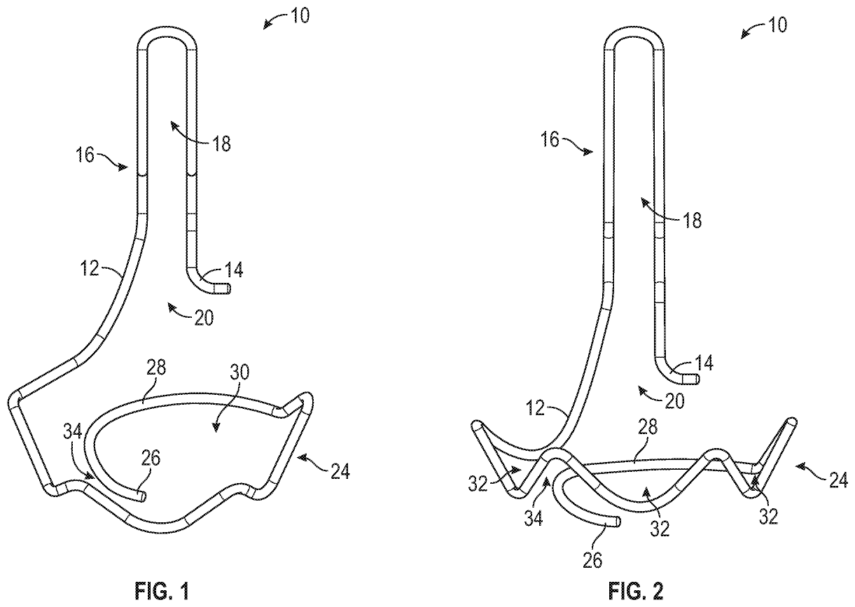

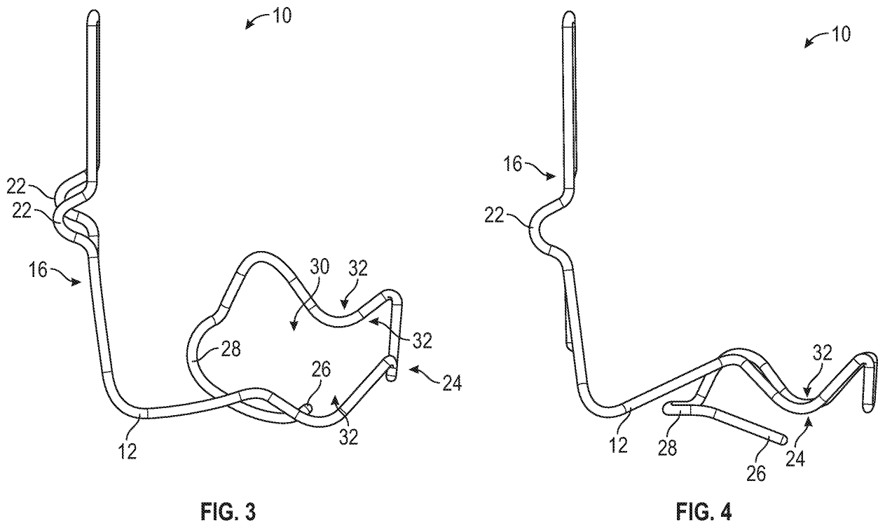

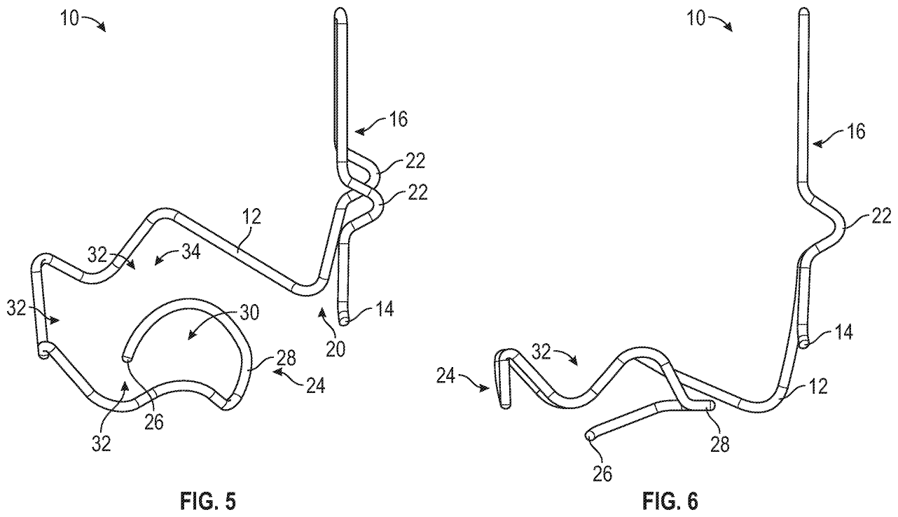

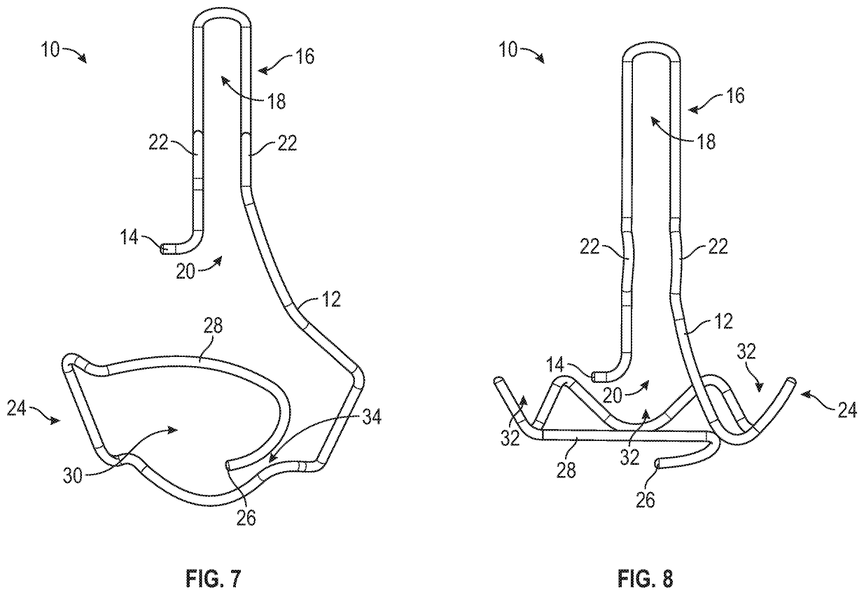

FIGS. 1-10 show an exemplary embodiment of a hanger device 10. The hanger device 10 is comprised of an elongate member 12 which is designed to form all of the features necessary to provide the functions of the device. The elongate member could made of any strong but lightweight material such as but not limited to wire, plastic, or aluminum. Near its first end 14, the elongate member 12 forms a vertically oriented surface mounting section 16 designed to enable the hanger device 10 to be hung or mounted to a wall, mirror, or other surface. As best seen in FIG. 2, the surface mounting section 16 defines an attachment gap 18 and an open bottom 20 and may include one or more bumper stops 22. As discussed in more detail herein, these features advantageously make it easy to affix the hanger device 10 to a wall, mirror, or other surface.

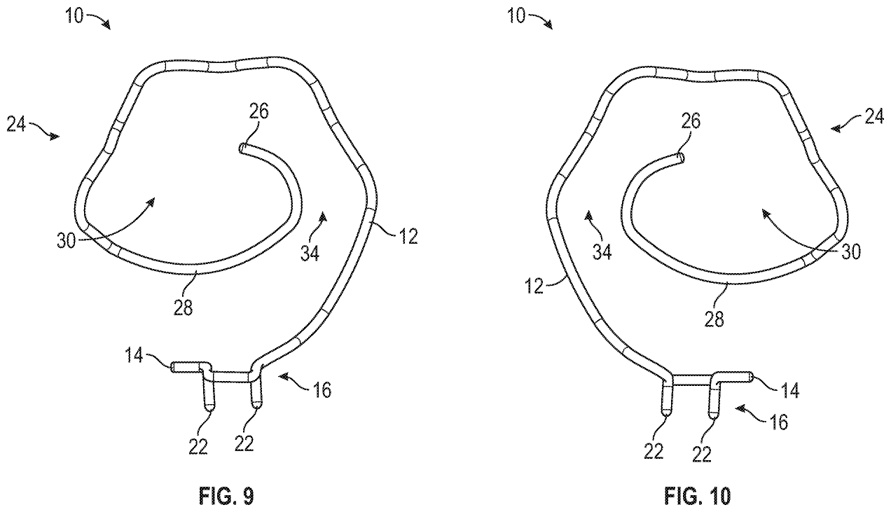

In exemplary embodiments, the elongate member 12 forms a support section 24 near its second end 26. As best seen in FIGS. 9 and 10, the support section 24 includes a substantially circular sway bar 28 which functions as the support for the blow dryer. More particularly, the sway bar 28 gently wraps or circles around to define receiving gap 30 and becomes a resting spot for the underneath of the dryer so that the dryer doesn't fall through the hanger device 10 and then continues just slightly around the dryer handle for additional support.

In exemplary embodiments, the support section 24 also defines directional slots 32. As discussed in more detail herein, the directional slots 32 hold the nozzle of the blow dryer. Depending on the application, there could be one directional slot or several and they could be sized and spaced in different ways depending on the blow dryer to be used with the hanger device. The directional slots 32 could also be various shapes such as circular, ovular, square, half-moon, triangular, or any other geometric shape or combination of shapes. As shown in FIG. 2, an exemplary embodiment has three directional slots 32. The support section 24 may also define an open pass-through 34 between a front or side section of the sway bar 28 and the directional slots 32. As discussed in more detail herein, the pass-through provides space for the cord of the blow dryer and facilitates removal of the dryer from the hanger device.

While multiple elongate members could be used to form different sections or features, in exemplary embodiments a single elongate member is used. In other words, the elongate member 12 is a single piece of wire, plastic, aluminum or other material that is continuous from the first end 14 all the way to the second end 26. The continuous flow of the single elongate member 12 forms the surface mounting section 16, the support section 24, and all other features of the device. More particularly, the first end 14 of the elongate member 12 flows into the surface mounting section 16, with the bumper stops 22 as part of a continuous flow. The elongate member 12 flows up, around and down to form the vertical orientation, an attachment gap 18, and open bottom 20 of the surface mounting section 16.

Then the elongate member 12 continues its flow, transitioning into the support section 24, with the directional slots 32 as part of the continuous flow. Finally, the elongate member 12 flows into the sway bar 28, again in one continuous sweep, and terminates at its second end 26. This design, using a single elongate member to form and define all the features of the device, is advantageous because it means the entire hanger device 10 is one continuous flow. Therefore, there is no need to tie down, screw in, snap on, or otherwise fasten, fuse, or connect anything in the manufacture or assembly of the hanger device 10. The hair dryer is supported in one free flowing motion and, as discussed in more detail herein, usage is one free flowing motion.

In exemplary embodiments, the hanger device 10 could be bendable and/or foldable at one or more locations to provide adjustability and improved positionability. For instance, the elongate member 12 could be made of a bendable material at the point where it transitions from the mounting section 16 to the support section 24. In other words, the device could be bendable at the bottom of the hanging device 10 before it slopes up into the directional slots 32. Bendability at that location creates up and down and/or side to side adjustability. This would allow the user to bend the support section 24 up or down and to adjust the position of the support section and the blow dryer 102 and enable it to be positioned further up or down and a little more side to side of the entire device if necessary.

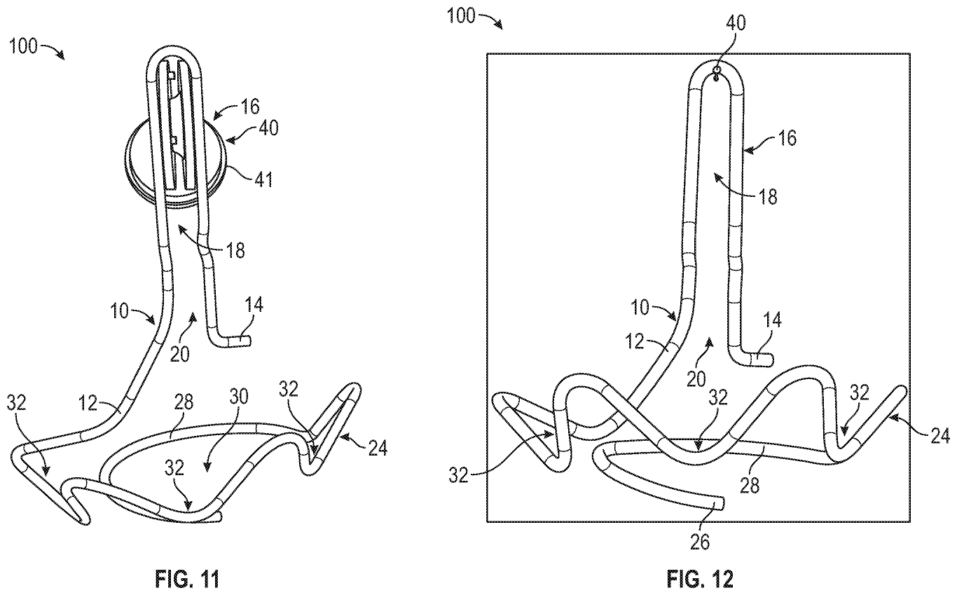

Turning to FIGS. 11 and 12, exemplary embodiments of a hanger assembly 100 comprise a hanger device 10 as described above—including an elongate member 12 forming a surface mounting section 16 and its features and a support section 24 and its features—plus a fastener 40 fitted through the attachment gap 18 of the surface mounting section 16. The fastener could be any mechanism suitable for affixing the device to a wall, mirror, or other surface including but not limited to a hook, a screw, a nail, tape or other adhesive. In exemplary embodiments, the fastener 40 is a suction cup 41. As discussed above, in exemplary embodiments the surface mounting section 16 has an open bottom 20 so the hanger device 10 can be hung on a nail in a wall or other surface. Alternatively, the fastener could be fitted through the attachment gap 18 of the surface mounting section 16. The bumper stops 22 stabilize the hanger device 10 against the vertical surface and provide additional forward direction of the air away from the surface toward the user. They also allow clearance for whatever fastener is attaching the device 10 to the vertical surface.

In operation, the user mounts the hanger device 10 to a wall or other surface by fitting a fastener 40 such as a suction cup 41 through the attachment gap 18 of the surface mounting section 16 and pressing the suction cup 41 onto the mounting surface. Alternatively, the user could attach a fastener 40 such as a suction cup 41, hook, screw, nail, adhesive, etc. to the wall or other surface and then hang the hanger device 10 onto the fastener 40 by holding the device 10 so the open bottom 20 of the surface mounting section 16 is above the fastener and then lowering the device down so the top of the surface mounting section 16 rests on the fastener 40. Advantageously, the attachment gap 18 and open bottom 20 of the surface mounting section 16 allow the hanger device to slip on or loop easily around any fixture or fastener. This open-ended design provides for simplicity of use. As illustrated in FIG. 12, because the surface mounting section 16 is vertically oriented and has stabilizing bumper stops 22, the hanger assembly 100 fits easily against a wall or other vertical surface with the necessary clearance for the fastener 40.

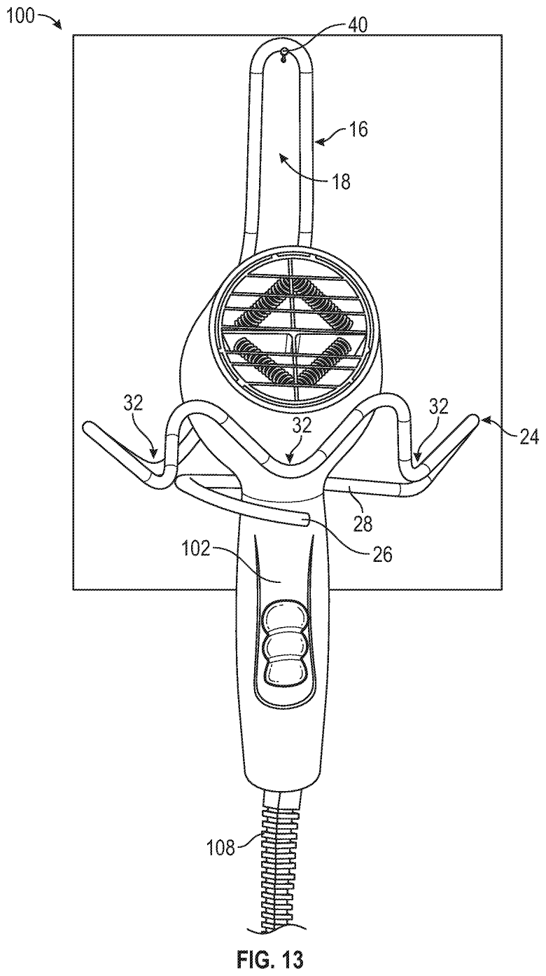

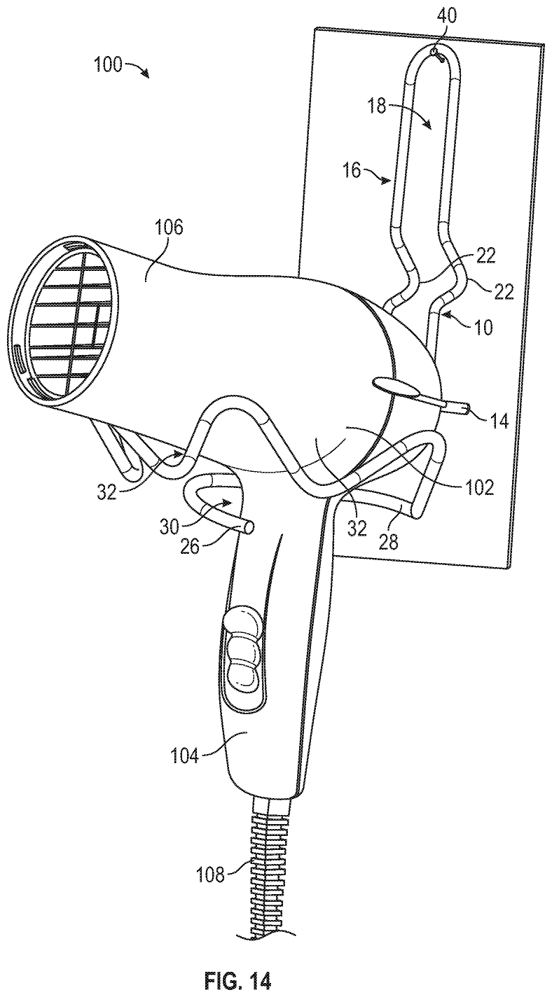

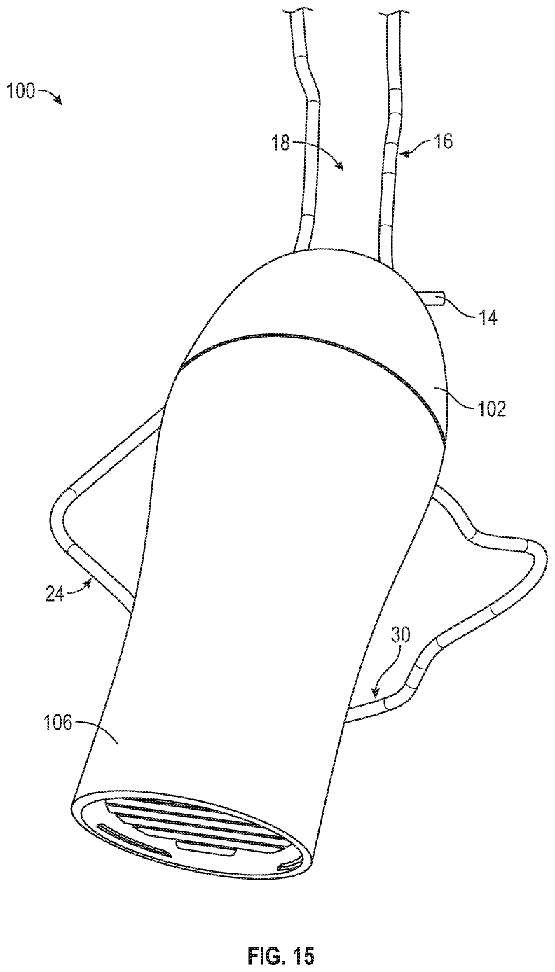

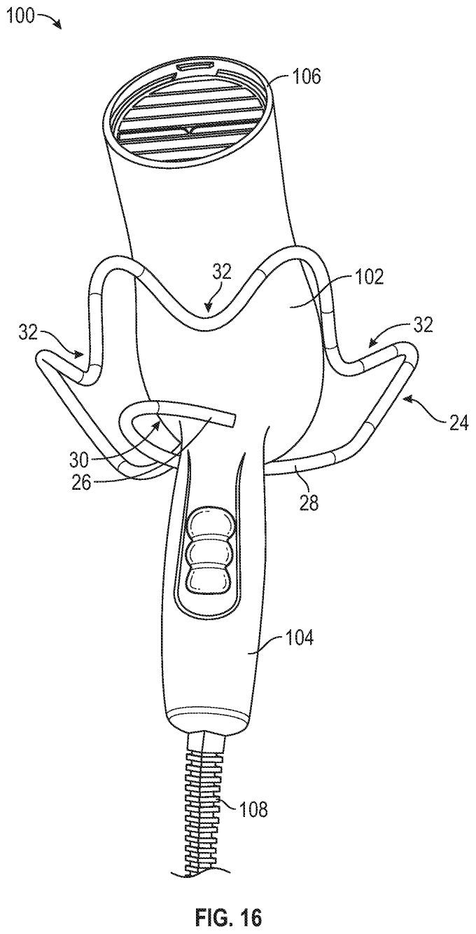

Once the hanger assembly 100 is mounted on the desired surface, the user can then mount a blow dryer in the hanger device 10 as shown in FIGS. 13-16. The user places the blow dryer 102 in the blow dryer support section 24 of the hanger device 10. More particularly, the user lowers the handle 104 of the dryer 102 into the receiving gap 30 defined by the substantially circular sway bar 28 so the handle 104 hangs vertically downward below the gap and the body of the underside of the blow dryer 102 rests on the sway bar 28, which functions as the support for the blow dryer. In other words, the sway bar 28 serves as a resting spot for the underside of the dryer so the dryer doesn't fall thru the hanger device 10. The user can rest the nozzle 106 of the blow dryer in any of the directional slots 32 to direct air flow as desired when the blow dryer is in use. In addition, the user can use the hanger device 10 to provide a resting place for the dryer and store the dryer when not in use.

When the user needs to use the dryer to blow dry his or her hair, the user would position the blow dryer 102 to rest the nozzle in the directional slots 32 so the nozzle 106 points to the direction the user needs the air to flow in. It should be noted that the bumper stops 22 provide additional forward direction of the air away from the surface toward the user. The directional slots 32 hold the nozzle 106 of the dryer 102 in the desired direction depending on where it is fixed to the surface, enabling the user to attach the hanger anywhere and still be able to use and see the mirror and access airflow as needed. The blow dryer is manually positionable, i.e., initial positioning and further positioning are manual, quick and easy. Simply by turning the dryer within the hanger device and positioning it into a different directional slot 32, the user can change the airflow direction as desired.

The easy, open pass-through 34 for the cord 108 allows for simple easy placement, movement, and use of the dryer 102. More particularly, the usage of the blow dryer 102 with the hanger assembly 100 is one free flowing motion due in part to the pass-through 34. To remove the blow dryer 102 from the hanger device 10 or replace it, the user holds the dryer 102 and spirals the cord 108 around the circular sway bar 28 and gently sets it into position. If quick removal of the dryer is needed there is nothing to release; the user just grabs the dryer and spirals it out of the hanger device. Advantageously, the design of the hanging device 10 and assembly 100 ensures that everything—hanging, using, removing, replacing—is perfectly balanced on its own.

While the disclosed systems and devices have been described in terms of what are presently considered to be the most practical exemplary embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

Thus, it is seen that improved hanging devices, systems, and methods for blow dryers are provided. It should be understood that any of the foregoing configurations and specialized components may be interchangeably used with any of the systems of the preceding embodiments. Although illustrative embodiments are described hereinabove, it will be evident to one skilled in the art that various changes and modifications may be made therein without departing from the disclosure. It is intended in the appended claims to cover all such changes and modifications that fall within the true spirit and scope of the disclosure.

What is claimed is:

1. A hanger device comprising:
at least one elongate member having a first end and a second end, the elongate member forming:
a surface mounting section near the first end defining an attachment gap; and
a support section near the second end;
wherein the support section includes a substantially circular sway bar defining a receiving gap and defines one or more directional slots.

2. The hanger device of claim 1 wherein the at least one elongate member is a single elongate member.

3. The hanger device of claim 1 wherein the surface mounting section includes one or more bumper stops.

3. The hanger device of claim 1 wherein the surface mounting section is vertically oriented.

4. The hanger device of claim 1 wherein the attachment gap defines an open bottom.

5. The hanger device of claim 1 wherein the one or more directional slots comprise three directional slots.

6. The hanger device of claim 1 wherein the support section defines an open pass-through between the sway bar and the directional slots.

7. The hanger device of claim 1 wherein the elongate member is comprised of one or more of: wire, plastic, and aluminum.

8. A hanger assembly comprising:
at least one elongate member having a first end and a second end, the elongate member forming:
a surface mounting section near the first end defining an attachment gap; and
a support section near the second end;
wherein the support section includes a substantially circular sway bar defining a receiving gap and defines one or more directional slots; and
a fastener fitted through the attachment gap.

9. The hanger assembly of claim 8 wherein the fastener affixes the hanger assembly to a vertical surface.

10. The hanger assembly of claim 8 wherein the fastener is a suction cup.

11. The hanger assembly of claim 8 wherein the fastener is one or more of: a hook, a screw, a nail, and tape.

12. The hanger assembly of claim 8 wherein the surface mounting section is vertically oriented.

13. The hanger assembly of claim 8 wherein the attachment gap defines an open bottom.

14. The hanger assembly of claim 8 wherein the surface mounting section includes one or more bumper stops providing clearance for the fastener.

15. A hanger device for mounting a blow dryer, comprising:
at least one elongate member having a first end and a second end, the elongate member forming:
a surface mounting section near the first end defining an attachment gap; and
a blow dryer support section near the second end;
wherein the blow dryer support section includes a substantially circular sway bar for resting an underside of a blow dryer, the substantially circular sway bar defining a gap configured to receive a blow dryer handle; and
wherein the blow dryer support section defines one or more directional slots for positioning a nozzle of a blow dryer in a desired direction.

16. The hanger device of claim 15 further comprising a fastener fitted through the attachment gap.

17. The hanger device of claim 15 wherein the blow dryer support section defines an open pass-through for an electrical cord between the sway bar and the directional slots to facilitate removal of a blow dryer.

18. The hanger device of claim 15 wherein the at least one elongate member is a single elongate member.

19. The hanger device of claim 15 wherein the surface mounting section includes one or more bumper stops providing clearance for the fastener.

20. The hanger device of claim 15 wherein the position of a blow dryer can be changed by turning the blow dryer and moving the nozzle from a first directional slot to a second directional slot.
